(19) United States
(12) Patent Application Publication
(10) Pub. No.: US 2017/0003215 A1
(43) Pub. Date: Jan. 5, 2017

(54) METHOD FOR QUANTITATIVE ESTIMATION OF FOULING OF THE SPACERS PLATES IN A STEAM GENERATOR

(71) Applicant: Electricite de France de France, Paris (FR)

(72) Inventors: Bruno RENARD, Paris (FR); Nicolas PAUL, Montreuil (FR)

(21) Appl. No.: 15/107,323

(22) PCT Filed: Dec. 23, 2014
(86) PCT No.: PCT/EP2014/079163

§ 371 Date: Jun. 22, 2016

(30) Foreign Application Priority Data
Dec. 23, 2013 (FR) 1363489

(51) Int. Cl. G01N 17/00; G06F 17/16; G21C 17/017; G06F 17/18

(52) U.S. Cl. CPC G01N 17/008; G06F 17/18; G06F 17/16; G21C 17/017; F01K 7/16

(57) ABSTRACT

The invention relates to a method for evaluating fouling of the passages of a spacer plate (10) of a shell-and-tube heat exchanger (11), wherein said passages (12a, 12b) are provided along the tubes (11) to allow fluid to flow through the spacer plate (10), wherein, for each of a plurality of at least one passage (12a, 12b): at least one measurement of a parameter dependent on fouling or the presence of magnetite is made in the vicinity of the passage, using an eddy current probe; this measurement is used to derive at least one indicator of the fouling of said passage, characterized in that said fouling is evaluated by comparing a set of one or more fouling indicator vectors of dimension of at least two, built from the fouling indicators thus obtained with a plurality of fouling indicator vector sets contained in a database, wherein each of said indicator vector sets is associated with a quantitative descriptor of fouling.

### TECHNICAL FIELD AND BACKGROUND OF THE INVENTION

The present invention generally relates to the field of inspecting tubes of heat exchanger with tubes. More specifically, the invention relates to a method for evaluating fouling of a spacer plate of a heat exchanger with tubes, said passages being made along the tubes and used for circulation of a fluid in said heat exchanger through said plate.

A steam generator generally consists of a bundle of tubes in which flows the hot fluid, and around which flows the fluid to be heated. For example, in the case of a steam generator of a nuclear power plant of the EPR type, the steam generators are heat exchangers which use the energy of the primary circuit from the nuclear reaction for transforming the water of the secondary circuit into the steam which will supply the turbine and thus produce electricity.

The steam generator brings the secondary fluid from a liquid water condition to the steam condition just at the limit of saturation, by using the heat of the primary water. The latter flows in tubes around which flows the secondary water. The outlet of the steam generator is the point with the highest temperature and pressure of the secondary circuit.

The exchange surface, physically separating both circuits, thus consists of a tubular bundle, consisting of 3,500 to 5,600 tubes, depending on the version, in which flows the primary water brought to a high temperature (320° C.) and to a high pressure (155 bars).

These tubes of the steam generator are maintained by spacer plates generally positioned perpendicularly to the tubes which cross them.

In order to let through the fluid which vaporizes, the passages of these spacer plates are foliated, i.e. their shape has lobes around the tubes. As the water passes from the liquid condition to the steam condition, it deposits all the materials which it contained. If material deposits are made in the lobes, they reduce the free passage: this is fouling, which is therefore the gradual obturation by deposits of holes intended for letting through the water/steam mixture.

FIG. 1 schematically illustrates a top view of a foliated passage in a spacer plate 10, in which passes a tube 11. The lobes 12a and 12b allow the water to cross the spacer plate 10 along the tube 11, thereby allowing flow of the water in the steam generator. A deposit 13 is visible at the lobe 12b, fouling said lobe 12b. The deposit may be located on the side of the tube and/or on the side of the plate.

Fouling leads to modifications of the flow of the water in the steam generator, and thus promotes the occurrence of excessive vibrations of the tubes, as well as to inducing significant mechanical forces on the internal structures of the steam generators. This degradation therefore has both effects on the safety and on the performances of the facilities. It is therefore indispensable to be well aware of the nature and of the time-dependent change in this degradation.

It is therefore sought to estimate the fouling level of these passages. This fouling level corresponds to the ratio between the blocked surface area of these passages over the total surface area of the latter. More generally this consists in quantitatively evaluating this fouling level.

Presently, the only non-destructive examination system which is capable of accessing the totality of the tubes/spacer plate intersections of the steam generators is the eddy current axial probe (SAX probe). Eddy currents appear in a conductive material when the magnetic flux is varied near the material. Thus a multi-frequency eddy current probe is thus circulated in a tube of said exchanger and with the latter a measurement signal is measured, depending on the environment in which the probe is found, from which it is possible to extract information as to the anomalies in the heat exchanger.

A variation of the magnetic induction, notably by a coil in which circulates an alternating current, generates eddy currents, for which the induced variation in the magnetic field is detected. Typically, the voltage difference generated by the variation of the impedance of the coil is measured.

Utilization of the measurement signals of this probe with eddy currents does not induce any extension of the standstill of the steam generator, since this eddy current probe is already used during shutdowns, notably for inspecting the integrity of the tubes of the steam generator.

This eddy current probe, initially intended for detecting damaging of the tubes, is also sensitive to fouling. Further, the interpretation of this signal is presently achieved manually by specialized operators, which takes a very long time, of the order of about one week of processing for analyzing a single steam generator. Further, the intervention of an operator for noting down the measurements from a piece of analysis software often gives rise to a bias which is difficult to quantify.

The evaluation of the fouled aspect of a foliated passage by an operator from the measurement signal is further not very reliable, as it is generally carried out empirically upon examination of the received signal.

The article “Tube Support Plate Blockage Evaluation with Televisual Examination and eddy Current Analysis” of L. Châtelier et al., AIP Conference proceedings, Vol. 1096, Jul. 25, 2008, pages 766, 773, describes the determination of a fouling level by means of calculation of an indicator called SAX ratio rₛₐₓ, which is a scalar indicator giving the possibility of measuring the fouling level from the amplitude difference of the signals of both sides of the spacer plate. This ratio rₛₐₓ is defined as being the ratio between the amplitude difference between the upper and lower edges of the spacer plate at the passage of the tube through the spacer plate, and the maximum of the two:

$${r}_{sax} = \frac{\vert {Y}_{1} - {Y}_{2} \vert}{max ( {Y}_{1} , {Y}_{2} )}$$

A correlation is demonstrated between the values assumed by the SAX ratio and the fouling level determined by remote viewing examination of the passages of the spacer plates. However, the correlation is limited to fouling levels of less than 50%, and because of the lack of accuracy between the value of the SAX ratio and the fouling level, the obtained accuracy is not satisfactory, so that it is only possible to obtain a broad estimation of the fouling, per fouling classes (0-15%, 15-25%, 25-50%).

Further, this correlation between the SAX ratio and the estimated fouling level by remote viewing examination depends on the type of steam generator. Further, in the case of perturbations which is common since the eddy current probe reacts to all the defects, the SAX ratio integrates all these perturbations and is then not representative of the fouling. For example, a fouling failure in the vicinity of the edge of the spacer plate has an influence on the signal of the eddy current probe, therefore on the SAX ratio, since the latter does not allow discrimination of the causes of the perturbation.

Document EP 2 474 826 A1 proposes a method for evaluating the fouling, wherein the eddy current measurements are noted, and the signals corresponding to the passages of the spacer plates are identified and then an average value is determined, which is used as an evaluation signal. Characteristics extracted from these signals are then used as fouling indicators and a fouling level is inferred therefrom. For example, the distance between the extreme points of a Lissajous representation may be used for determining the fouling level, by means of a predetermined calibration curve relating said distance to a fouling level.

In another example, the comparison is carried out by means of a predetermined equation. The equation is described as having been obtained by data read-out means on a device for which the fouling characteristics are known. The fouling level corresponds to the result of the equation assuming as variables the fouling indicators.

These methods therefore imply predetermination of a model which is expressed by a calibration curve or by an equation. They therefore assume a simple relationship between the extracted characteristics and the fouling level, and assume that a fouling level is expressed by a same signal shape. Now, it is found that this is not the case, and that a same fouling level may give varied signals, and that consequently it is not possible to simply model the relationship between the measurement signal and the fouling level. These methods therefore do not allow proper appreciation of the fouling level.

Document EP 2 584 254 A2, in a similar context to the preceding one, proposes a method aiming at predicting the time-dependent change in the fouling by determining for each passage through the spacer plate, the fouling level. For this purpose, a model for viewing the spacer plates illustrating the fouling of the passages and their time-dependent change is provided. This time-dependent change is determined by means of a fouling curve which is determined by measurements via visual inspections and via eddy currents.

In order to determine the evaluation fouling curve, a relationship is established between the actual fouling level obtained by visual inspection of a passage and a fouling indicator from the signal of the corresponding eddy current probe, for example a distance on a Lissajous representation as earlier. Subsequent measurements with eddy currents give the possibility of readjusting the estimation of the fouling rate by estimating the fouling level by comparing the fouling indicator determined from the signal of the eddy current probe with the fouling evaluation curve.

The method proposed by document EP 2 584 254 A2 is therefore based on the same assumption as that of document EP 2 474 826 A1, i.e. the existence of a representative model of a simple relationship between the measurement signal and the fouling level. Now, experiment has shown that this is not the case, and therefore the proposed methods do not allow correct estimation of the fouling level.

### PRESENTATION OF THE INVENTION

A general object of the invention is to overcome all or part of the defects in the methods for evaluating fouling of foliated passages around tubes in the spacer plates of the state of the art, by proposing a comparison of a vector consisting of several fouling indicators with other vectors consisting of several fouling indicators.

A method for evaluating the fouling of passages of a spacer plate of a heat exchanger with tubes is notably proposed, said passages being made along the tubes for crossing the spacer plate with a fluid, wherein, for each of at least one passage:

at least one measurement of a parameter depending on the fouling or on the presence of magnetite is conducted in the vicinity of the passage by means of an eddy current probe,

at least one fouling indicator of said passage is derived from this measurement,

characterized in that the fouling is evaluated by comparing a set of one or several vectors of fouling indicators with a dimension of at least two, built from the thereby obtained fouling indicators, with a plurality of sets of vectors of fouling indicators contained in a database, each of said sets of vectors of fouling indicators of the database being associated with a quantitative fouling descriptor.

This method is advantageously completed by the following characteristics, taken alone or in any of their technically possible combinations:
the sets of vectors of fouling indicators are represented by distributions of vectors of fouling indicators of passages of a spacer plate portion and the quantitative descriptor associated with each distribution is an average fouling level of the passages of said spacer plate portion, said database dealing with at least N portions of spacer plates of different heat exchangers, N≧2, and including N distributions of vectors of indicators each associated with an average fouling level of the passages of said spacer plate portion;
the distributions of vectors of fouling indicators are associated with spatial information, so as to correspond to representative images of the spatial distribution of the fouling values;
the method comprises steps according to which
   the distribution of vectors of indicators Pₜₑₛₜ(θ) of the inspected plate portion is determined,
   a similarity measurement dₙ, between the distribution of vectors of indicators Pₜₑₛₜ(θ) of the inspected spacer plate portion and each of the distributions of vectors of indicators Pₙ(θ) of the database is calculated,
   K distributions of vectors of indicators Pₙ(θ) of the database are selected, for which the similarity measurements dₙ, with the distribution of indicators Pₜₑₛₜ(θ) of the inspected spacer plate portion are the greatest,
   the fouling is determined from fouling levels associated with said selected K distributions of vectors of indicators Pₙ(θ) of the database;
the determination of the fouling comprises a step according to which:
   an average of the fouling levels associated with said selected K distributions of vectors of indicators Pₙ(θ) of the database is calculated, each fouling level being weighted by the similarity measurements between the distribution of vectors of indicators Pₙ(θ) of the database with which it is associated and the distribution of vectors of indicators Pₜₑₛₜ(θ) of the inspected spacer plate portion;
the method further comprises a determination of an evaluation of the uncertainty on the thereby determined fouling, on the basis of the measurement of the similarity between the thereby selected K distributions of vectors of indicators Pₙ(θ) of the database and the distribution of vectors of indicators Pₜₑₛₜ(θ) of the inspected spacer plate portion and/or of the variability of the quantitative fouling descriptors associated with the distributions of vectors of indicators of the selected spacer plate portion;
the calculation of the measurement of similarity dₙ, between the distribution of vectors of indicators Pₜₑₛₜ(θ) of the inspected spacer plate portion and each of the distributions of vectors of indicators Pₙ(θ) of the database comprises an estimation of the distributions by means of a probability law model [symbol] , preferably a Gaussian law, a Parzen modeling or a weighted average of probability laws;
a set of vectors of fouling indicators is a vector of fouling indicators of a tube and the quantitative descriptor associated with said vector is a fouling level of said tube, said database dealing with at least M tubes of different heat exchangers, M≧2, said database including M vectors of fouling indicators of a passage, each associated with a fouling level of said passage;
the method comprises the steps according to which:
   the vectors of indicators θ of the inspected tube is determined,
   the a posteriori fouling c distribution, (p(c|θ)), is calculated for the vectors of indicators θ of the inspected tube from the vectors of indicators of the database,
   the fouling is determined by the sum of the a posteriori fouling distribution p(c|θ) weighted by the fouling;
the calculation of the a posteriori law comprises an estimation of the a priori law p(c) and of the likelihood p(θ|c);
the a priori law is determined by a ratio between:
   the number Mₖ of tubes of the database having a fouling level c comprised in an interval [cₖ; cₖ₊₁], and
   the total number of tubes in the database;
the likelihood law is approached on c comprised in an interval [cₖ: cₖ₊₁] by a probability law [symbol] , preferably a Gaussian law, a Parzen modeling or a weighted average of laws;
the set of vectors of fouling indicators of the database are packets each having a center or an average and grouping on the basis of a similarity measurement dealing with the values of said vectors of fouling indicators, the vectors of fouling indicators which are the closest, in the sense of the similarity measurement, to said center or to said average, a quantitative fouling descriptor being associated with each of said packets, and wherein, for a set of one or several vectors of fouling indicators of the inspected tube or plate portion:
   each of the vectors of indicators of the set of vectors of fouling indicators of the inspected tube or plate portion are each compared with the respective centers or averages of the packets of the database by a similarity measurement,
   m packets of vectors of fouling indicators are selected on the basis of this comparison,
   the fouling level of the inspected tube or plate portion is determined from quantitative descriptors associated with m packets of selected vectors of indicators.

Preferably, the fouling level of the inspected tube or plate portion is determined from an average of the quantitative descriptors of each packet weighted from the calculated similarity measurements.

The invention also relates to a computer program product comprising program code instructions for executing the steps of the method according to the invention when said program is executed on a computer.

### PRESENTATION OF THE FIGURES

Other features, objects and advantages of the invention will become apparent from the following description, which is purely illustrative and non-limiting, and which should be read with reference to the appended drawings wherein:

FIG. 1, having already been commented, schematically illustrates, in a top view a foliated passage in a spacer plate, in which passes a tube, according to a common configuration of a steam generator;

FIG. 2 schematically illustrates the steps of the method according to a first alternative of the invention;

FIG. 3 schematically illustrates the steps of the method according to a second alternative of the invention.

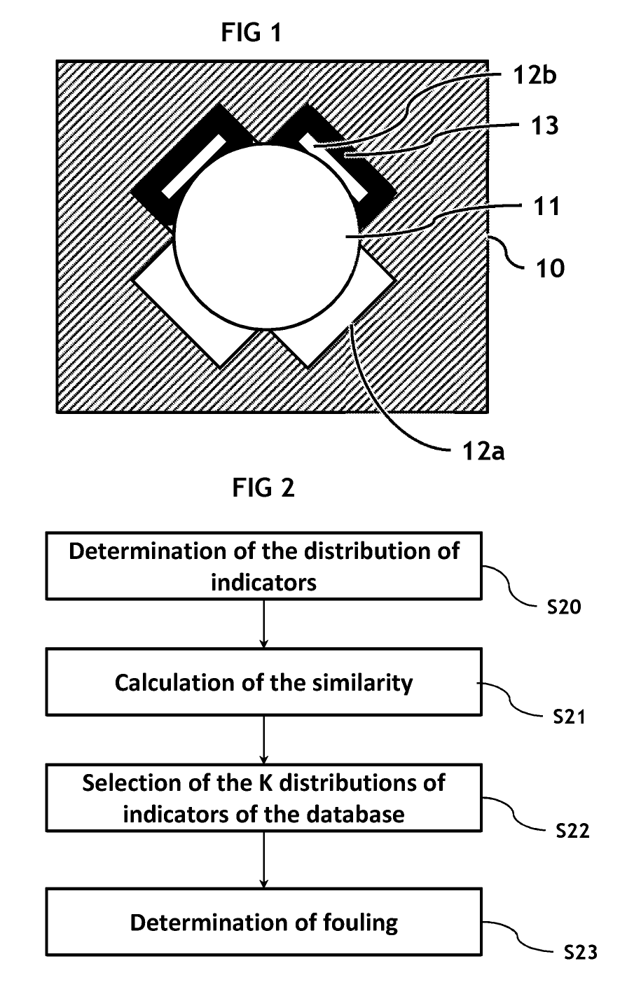

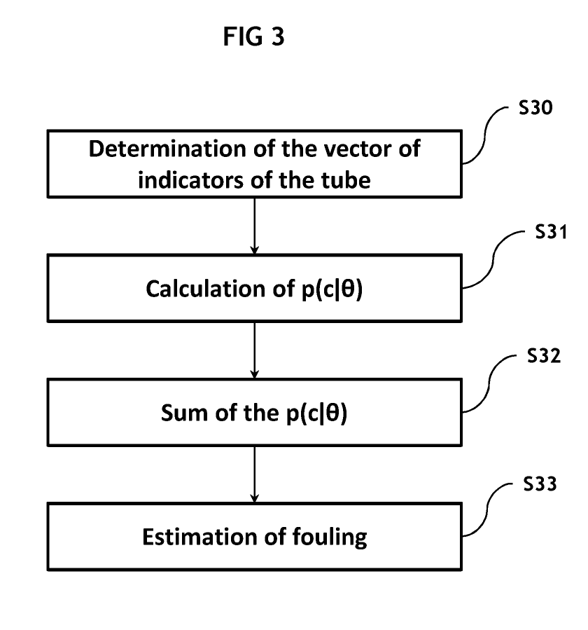

### DETAILED DESCRIPTION

The method in a way known to one skilled in the art begins by, in the vicinity of passages, conducting at least one measurement of a parameter depending on the fouling or on the presence of magnetite, typically by means of an eddy current probe, the measurement of which is representative of the impedance variations which fouling may cause, for example by magnetite.

Next from this measurement at least one fouling indicator of said passage is derived. The description below gives a non-limiting example of deriving such a fouling indicator.

After extraction from the measurement signal of a signal corresponding to the passage of the downstream edge of the spacer plate 10 by the probe, and from a signal corresponding to the passage of the upstream edge of the spacer plate 10 by the probe, it is then proceeded with the determination from the measurement signal of a lower edge signal corresponding to the passing of the downstream edge of the spacer plate 10 by the probe, and of an upper edge signal corresponding to the passage of the upstream edge of the spacer plate 10 by the probe.

The eddy current probe typically acquires at least partly the measurement signal in a differential mode, and the measurement signal is a multi-frequency signal consisting of at least two signals at different frequencies.

Preferably, only the signals corresponding to the differential mode (z₁ and z₃) are used since they are more sensitive to the passage of the spacer plate 10. These signals are acquired at different frequencies and the lower edge signal is determined as a linear combination of at least two signals at different frequencies of said measurement signal, in this case z₁ and z₃.

This linear combination involves a complex coefficient ∝ optimized for minimizing the signal power along the tube 11 outside the spacer plate areas 10.

Thus, the lower edge signal z_{inf} is determined from signals obtained in a differential mode on the frequencies f3 and f1, so that

z_{inf}[n]=z_{3inf}[n]−∝·z_{1inf}[n],

with ∝=argmin∥z₃[n]−∝×z₁[n]∥²,

for the indices n corresponding to the signal outside the spacer plate areas 10, and z_{3inf} corresponding to the response of the probe in a differential mode on frequency f3 during the passage of the downstream edge, i.e. lower edge, of the spacer plate 10 by the probe, and z_{1inf} corresponding to the response of the probe in a differential mode on frequency f1 during the passage of the downstream edge, i.e. lower edge, of the spacer plate 10 by the probe.

One proceeds in the same way with the upper edge signal, with preferably the same coefficient ∝, so that zₛᵤₚ [n]=z₃ₛᵤₚ[n]−∝z₁ₛᵤₚ[n], with Z₃ₛᵤₚ corresponding to the response of the probe in a differential mode on frequency f3 during the passing of the upstream edge, i.e. upper edge, of the spacer plate 10 by the probe, and z₁ₛᵤₚ corresponding to the response of the probe in a differential mode on frequency f1 during passing of the upstream edge, i.e. upper edge, of the spacer plate 10 by the probe.

Thus two complex signals are obtained. The lower edge signal z_{inf} is written as:

z_{inf}[n]=x_{inf}[n]+i. y_{inf}[n]

with x_{inf} and y_{inf} the respectively real and imaginary components of the lower edge signal and i the imaginary unit such that i²=−1. Also, the upper edge signal zₛᵤₚ is written as:

zₛᵤₚ[n]=xₛᵤₚ[n]+i. yₛᵤₚ[n]

with xₛᵤₚ and yₛᵤₚ being the respectively real and imaginary components of the upper edge signal and i being the imaginary unit such that i²=−1.

An adequate processing of these signals therefore remains to be applied in order to evaluate the fouling of the passage of the spacer plate 10. This processing is applied on the lower edge signal, which is a complex signal. Indeed, the fouling of the foliated passages, i.e. the lobes 12a, 12b in the spacer plates 10 occurs at the lower edge of the spacer plates 10, upstream from the passage for the fluid flow passing through the spacer plate 10. It is therefore from the lower edge signal that it is possible to estimate the fouling level.

More specifically, the lower edge signal is de-convoluted by the complex impulse response of the probe.

In fact, in an ideal case of a perfect SAX probe, the signal should only contain a sequence of complex pulses, corresponding to the passage through a spacer plate edge 10, to the encounter of a deposit, and the study of the sole lower edge signal should be sufficient for quantifying the fouling.

However, in practice, the response of the SAX probe to an impedance variation is not perfect. This is called the impulse response of the probe. Therefore it is necessary to restore the lower edge signal in order to again find the response of the probe representative of the fouling condition of the foliated passage in the spacer plate 10.

For this purpose an estimation of the impulse response of the probe is determined, preferably corresponding to the passage of a specific edge of the spacer plate 10 by the probe in the tube 11, for example from the upper edge signal. It is then sought to de-convolute the lower edge signal z_{inf}[n] with a signal h[n] corresponding to the impulse response of the probe upon passing the spacer plate.

To do this, it is possible to use a filter. Such a filter is called a deconvolution filter or further a restoration filter. The deconvolution filter is calculated from the estimation of the impulse response, and it applies a deconvolution of the lower edge signal by means of said deconvolution filter. The deconvolution filter may be an approximation of the reciprocal of the impulse response of the probe. It may also be a Wiener filter and the deconvolution may thus be a Wiener deconvolution, which is a preferential embodiment of the described method. Other deconvolution methods exist and may be used.

For example, it is possible to search for the de-convoluted lower edge signal z_{inf,id}[n] which at best corresponds to the lower edge signal z_{inf}[n] which was observed:

z_{inf,id}[n]=argmin_{z[n]{}J₁(z_{inf}[n] [symbol] h[n])+λ×J₂(z[n])}

with J₁ being the criterion suitable for the data (for example a standard L_{2,} a standard L₂ squared, a standard L_{1,} . . . ) and J₂ a criterion expressing a characteristic a priori known on the signal which one seeks to rebuild (for example a standard L2, a standard L₂ squared, a standard L_{1,} a function of the deviations between neighboring samples z[n]−z[n−1]). The term λ gives the possibility of assigning more or less importance to the a priori on the solution (J₂) relatively to the suitability to the data (J₁). This criterion may also be written in the frequency domain.

Therefore there are several alternative deconvolution criteria J1 and J2 which may be used, and for each alternative, several resolution methods, for example by filtering or by optimization methods.

In the case when the deconvolution filter is a Wiener filter, the frequency response of the Wiener filter is of the form:

$$G [ f ] = \frac{{H}^{*} [ f ]}{{‖ H [ f ] ‖}^{2} + \frac{B [ f ]}{S [ f ]}}$$

with the exponent * designating the complex conjugation, H[f] the Fourier transform of the impulse response of the probe, S[f] the spectrum power density of the signal to be estimated and B[f] the spectrum power density of the noise. Zero-padding, i.e. adding zeros within the signals, may be carried out during the calculation of the discrete Fourier transforms in order to increase the frequency resolution.

The impulse response h[n] of the probe may be estimated from the response of the probe upon passing the upstream edge of the spacer plate 10 by the probe, i.e. by means of the upper edge signal, according to the formula:

h[n]=−zₛᵤₚ[−n]

For example, from processing operations carried out for extracting the useful portions of the measurement signal, indices i_{inf} and iₛᵤₚ of the measurement signal respectively corresponding to the passages of the lower and upper edges of the spacer plate 10 are known. For a sampling frequency Fe=1,000 Hz, a velocity of the probe v=0.5 m.s⁻¹ and a spacer plate length 10 of 30 mm, one has 60 signal samples corresponding to the spacer plate 10, and an impulse response of about 20 samples. It is then possible to select for the range of values of the upper edge signal zₛᵤₚ[n], the 60 samples according to the center of the spacer plate 10 determined to be about 0.5×(i_{inf}+iₛᵤₚ), i.e. a margin of 20 samples on each side of the impulse response. These figures are of course indicated as a non-limiting example of the use of the upper edge signal zₛᵤₚ[n] for estimating the impulse response of the probe.

Several approaches are possible for estimating the noise-to-signal ratio corresponding to the ratio of the power spectral density of the noise B[f] and of the spectral power density S[f] of the signal to be estimated. One of these approaches consists of approximating this ratio with a constant. Indeed, the signal to be estimated corresponds to an ideal lower edge signal which would have a sequence of pulses corresponding to the complex impedance variations encountered by the probe in the vicinity of the lower edge of the spacer plate 10. Consequently, the power spectral density S[f] of this signal may be considered as a constant. The power spectral density of the noise B[f] may be determined on the portions of the signal between the spacer plates 10. The latter may be assimilated to white noise, and therefore this power spectral density of the noise B[f] may be considered as a constant. Thus, the ratio of the power spectral densities of noise and of the signal to be estimated may be considered as a constant. This constant may be adjusted empirically, for example by assuming:

$$\frac{B [ f ]}{S [ f ]} = 10 {σ}^{2} ,$$

with σ² the power of the noise, calculated on an area outside the plates.

Once the deconvolution filter is determined, it is then possible to proceed with deconvolution of the lower edge signal by means of said deconvolution filter. The deconvolution filter g is then applied to the lower edge signal z_{inf} in order to obtain a complex de-convoluted lower edge signal z_{inf id} introduced by the impulse response of the probe:

z_{inf id}=z_{inf}* g

In practice, this operation may be carried out in the frequency domain:

z_{inf id}=TF⁻{Z_{inf}[f]×G[f]},

with Z_{inf}[f] the Fourier transform of the lower edge signal z_{inf}, G[f] being the Fourier transform of the deconvolution filter g, and TF⁻¹ indicating the inverse Fourier transform.

In order to avoid too substantially amplifying certain frequencies only corresponding to measurement noise, filtering with a low-pass filter is applied to the de-convoluted lower edge signal, the cutoff frequency of said low-pass filter being determined by means of a standard deviation of a Gaussian function forming an approximation of the real portion of a lower edge signal pulse corresponding to the passing of the edge of the spacer plate 10.

Indeed, the real or imaginary portion of the lower edge signal impulse corresponding to the passing of the edge of the spacer plate 10 has shapes very close to Gaussian functions or to their derivatives. For example, the impulse 0 in the real portion of the lower edge signal corresponding to the passing of the lower edge of the spacer plate 10 in a configuration without fouling may be assimilated to a Gaussian function, and a linear combination of derivatives of the Gaussian function may be assimilated to pulses in the imaginary portion of the lower edge signal corresponding to the passing of the lower edge of the spacer plate 10 in a fouled configuration.

If σ is the standard deviation of this Gaussian function, generally of the order of 3 or 4 samples, the Fourier transforms of the signals to be de-convoluted no longer contain any energy beyond a maximum frequency fₘₐₓ:

$${f}_{max} = \frac{3}{2 πσ} .$$

Therefore it is possible to select this maximum frequency fₘₐₓ as a cutoff frequency of the low-pass filter.

Once the lower edge signal is de-convoluted and thus filtered, there remains analysis of the latter for evaluating the fouling. Following the process described above, during which at least one measurement of a parameter depending on the fouling or on the presence of magnetite, of fouling indicators of said passage which are derived from this measurement are then available.

Diverse types of indicators may be used. For example, if one designates by y+ (respectively y−) the positive values (respectively negative values) assumed by the imaginary portion of the signal obtained in the vicinity of the lower edge of the plate after deconvolution, and if the various following quantities are defined as:

E_{Y+}/E_{Y-}:energy of y+ and of y−

P_{Y+}/P_{Y-}:power of y+ and y−

M_{Y+}/M_{Y-}: maximum value of y+ and of |y−|

Γ_{Y+}/Γ_{Y-}: standard deviation of the values assumed by y+ and by y− It is also possible to take the minimum and maximum values of the quantities below, for example for each pair of physical quantities, X_{Y+}/X_{Y-}, with X corresponding to E, P, M or Γ, and a minimum indicator and a maximum indicator may be defined:

Xₘᵢₙ=min {X_{Y}+, X_{Y}−}

Xₘₐₓ=max {X_{Y}+, X_{Y}−}.

The fouling is then evaluated by comparing a set of one or several vectors of fouling indicators, of the dimension of at least two, built from the thereby obtained indicators, with a plurality of sets of vectors of fouling indicators contained in a database, each of said sets being associated with a quantitative fouling descriptor. A vector of fouling indicators is preferably of a dimension of at least two, i.e. it is not preferably a scalar.

Each vector of indicators is of a dimension of at least two, which means that it comprises at least two indicators as components. For example, it is possible to build an vector of indicators comprising as components:
the energy E_{Y}+ of the positive values assumed by the imaginary portion of the signal obtained in the vicinity of the lower edge of the plate after deconvolution, and
the energy E_{Y}− of the negative values assumed by the imaginary portion of the signal obtained in the vicinity of the lower edge of the plate after deconvolution.
   The vector of indicators is then written as (E_{Y}+;E_{y}−). Other vectors of indicators may be used, combining two or more indicators,

The fouling indicators contained in a database are typically fouling levels from remote viewing examination (RVE). The design of the steam generators actually allows inspection of their upper spacer plate via an automated camera. On each photograph, one of the foliages of the tube/plate intersection is observed. The fouling level of the observed foliated passage is evaluated by measuring the section reduction at the lower edge. By considering that the obstruction phenomenon is homogeneous on each of the foliages of the tube/plate intersection, the fouling level of the passage of the latter is obtained.

This method, unlike the examination by an eddy current probe; gives the possibility of having a quantitative indication of the fouling level of the plate, which forms a quantitative fouling descriptor. But it is only applicable to the upper spacer plate, except for certain types of steam generators, also allowing the passing of the image-shooting apparatus over a few tubes of the intermediate plate. The RVE therefore does not give the possibility of obtaining the profile of the fouling on the whole of the steam generator. On the other hand, on an inspected plate, the peripheral tubes remain inaccessible.

These remote viewing examinations have however been carried out for a long time, and the results have been stored in databases, so that a large amount of data exists which may be utilized for inferring therefrom the quantitative evaluation of the fouling by combining the quantitative evaluations of the remote viewing examinations passed with an inspection of the tubes with eddy currents.

It should be noted that the steps of the following methods are applied with at least one computer, one central or processing unit, an analog electronic circuit, a digital electronic circuit, a microprocessor, and/or software means.

Estimation on the Whole of a Plate Portion

In a first alternative of the method, it is sought here to estimate directly the average fouling level per spacer plate portion, without requiring an evaluation of the fouling of each of its tubes.

The sets of fouling indicators of the database are therefore represented by distributions of vectors of fouling indicators of passages of a spacer plate portion and the quantitative descriptor associated with each distribution is an average fouling level of each of the passages of said spacer plate portion, said database dealing with at least N portions of spacer plates of different heat exchangers, N≧2, and including N distributions of vectors of indicators each associated with an average fouling level of the passages of said spacer plate portion.

In the example hereafter, the spacer plate portions are half-spacer-plates, corresponding to the portion of the spacer plates present in the cold or hot branch of the heat exchanger, here a steam generator. It is therefore assumed that one has N half-plates for which the fouling level is determined from the remote viewing examination Cₙ and the values of the vectors of indicators θ for each of their tubes.

Approach by Similarity Measurement Between Distributions of Vectors of Indicators

A first approach lies on similarity measurements between distributions of vectors of indicators. The principle of this approach is to recognize in the available database, the distributions of vectors of indicators the most similar to the one of the half-plate which is intended to be evaluated. The Pₜₑₛₜ(θ), the distribution of the vectors of indicators of the inspected half-plate, and Pₙ,(θ) (n ∈ [[1, N]]) the distributions of the vectors of indicators of N half-plates available in the database are considered.

Thus, after having determined the distribution of the vectors of indicators Pₜₑₛₜ(θ) of the inspected plate portion (step S20), a similarity measurement dₙ, is calculated between the distribution of vectors of indicators Pₜₑₛₜ(θ) of the inspected spacer plate portion and each of the distributions of vectors of indicators Pₙ(θ) of the database (step S21).

The similarity measurement between distributions may for example be evaluated by means of a distance function which will be noted as D. The distance dₙ is thus calculated between the distribution of vectors of indicators of the plate to be evaluated Pₜₑₛₜ(θ) and each of the distributions Pₙ(θ) of the database:

dₙ=D(Pₜₑₛₜ, Pₙ)

There exist several similarity measurements which may be used. It is notably possible to use for example the Kullback-Leibler divergence, the Bhattacharyya distance or further the Hellinger distance. The latter in particular provides the advantage of giving a result limited between 0 and 1, thus proving to be interpretable in absolute terms. Its formula is given by the following equation:

D_{H}(P, Q)=1/\sqrt{2}\sqrt{Σᵢ(\sqrt{pᵢ}−\sqrt{qᵢ})²}

with p and q the vectors of indicators of the distributions of vectors of indicators P and Q, respectively.

It is then possible to select (step S22), from among the N thereby calculated distances, the K smallest ones (K ∈ [[1, NJ]]), therefore corresponding to the most similar distributions. The K distributions of indicators Pₙ,(θ) of the database are thus selected, the similarity measurements of which with the distribution of indicators Pₜₑₛₜ(θ) of the inspected spacer plate portion are the greatest, are therefore selected. When the similarity measurement is a distance, this therefore amounts to taking the smallest K distributions.

The fouling (step S23) is then determined from the fouling levels associated with said selected K distributions of vectors of indicators Pₙ,(θ) of the database.

It is possible to calculate an average of the fouling levels associated with said selected K distributions of vectors of indicators Pₙ,(θ) of the database, each fouling level being weighted by the similarity measurement between the distribution of vectors of indicators Pₙ,(θ) of the database with which it is associated and the distribution of vectors of indicators Pₜₑₛₜ(θ) of the inspected spacer plate portion.

The average of the foulings of these K half-plates are then weighted with their respective distances with the distribution of vectors of indicators of the half-plate to be evaluated, so as to give more weight to the most similar ones:

$${\hat{c}}_{test} = \frac{{Σ}_{k = 1}^{K} {d}_{k}^{- 1} {c}_{k}}{{Σ}_{k = 1}^{K} {d}_{k}^{- 1}}$$

The calculation of the similarity measurement dₙ, between the distribution of vectors of indicators Pₜₑₛₜ(θ) of the inspected spacer plate portion and each of the distributions of vectors of indicators Pₙ(θ) of the database may comprise an estimation of the distributions by means of a model of a probability law [symbol] , preferably a Gaussian law, a Parzen modeling or a weighted average of probability laws.

Indeed, measuring distances between distributions however requires estimation of the latter. They may be then approached with a probability law [symbol] model, a function of parameters cu to be determined, built according to the observations which are available:

P(θ)≈ [symbol] (θ, ω)

The question of the selection of [symbol] is open: the latter may for example deal with a multidimensional Gaussian law:

P(θ)≈N(θ, μ, Σ)

wherein μ represents the average vector of indicators of the half-plate, and Σ is its variance-covariance matrix (both of these elements forming the parameters of the distribution to be calculated).

Also it is possible to turn towards Parzen modeling. Its principle is to place a kernel function, for example a Gaussian on each of the observations of the statistical population for which one seeks to estimate the probability density. The sum of all these Gaussians gives the Parzen likelihood.

In the relevant case, the observations are the vectors of indicators extracted from each of the tubes. The distribution of the vectors of indicators of the half-plate n including Mₙ, tubes of vectors of indicators θₘ (m ∈ [[1, Mₙ]]) of dimension d is then given by:

$${P}_{n} ( θ ) = \frac{1}{\sqrt{\vert {Σ}_{n} \vert} {( 2 π )}^{\frac{d}{2}} {h}^{d}} {\sum }_{m = 1}^{{M}_{n}} exp ( - \frac{1}{2 {h}^{2}} {( θ - {θ}_{m} )}^{T} {Σ}_{n}^{- 1} ( θ - {θ}_{m} ) )$$

The parameter h represents the variance of the Gaussian (i.e. its width) to be applied on each of the observations. Usually the same value is used on each of the observations. For example it is possible to assume that h=0.5. The variance-covariance matrix Σₙ is calculated on the whole of the vectors of indicators belonging to the half-plate n. This inverse matrix may be approached by the matrix formed with its sole inverse diagonal coefficients, according to

$${Σ}_{n}^{- 1} = {( {σ}_{i , j} )}^{- 1} \approx ( \begin{matrix}\frac{1}{{σ}_{1 , 1}} & … & 0 \\ ⋮ & ⋱ & ⋮ \\ 0 & … & \frac{1}{{σ}_{d , d}}\end{matrix} )$$

with i, j ∈ [[1, d]].

Moreover, the similarity measurement between distributions gives the possibility of introducing an uncertainty score of the result: small distances between a half-plate to be evaluated and certain half-plates of the database predict strong similarity with fouling examples already observed, and therefore high confidence in the result. Conversely, an atypical half-plate differing from the available history, will see its distribution of vectors of indicators moved away from all the others, expressing greater uncertainty on the result of the estimation.

The method may thus comprise a determination of the uncertainty evaluation on the thereby determined fouling, on the basis of the similarity measurement between the K distributions of vectors of indicators Pₙ(θ) of the database which were thereby selected and the distribution of vectors of indicators Pₜₑₛₜ(θ) of the inspected spacer plate portion, and/or the variability of the quantitative descriptors associated with the distributions of vectors of indicators of a spacer plate portion, i.e. the half-plates.

### Approach by Vector Quantification

Another approach lies on vector quantification. The principle of vector quantification is to partition a large number of data (vectors of a given space) into a restricted number of packets (or “cluster”) in the sense of a similarity measurement (generally a distance). Thus the space of the vectors of indicators θ is separated into K packets, K being a parameter of the algorithm determined beforehand, each including a center or an average. Each vector of indicators θ belongs to the cluster for which the center or the average is the closest.

Thus, the sets of vectors of fouling indicators of the database are then packets having each a center or an average, and grouping on the basis of a similarity measurement dealing with the vectors of fouling indicators, the vectors of fouling indicators which are the closest to said center or said average, in the sense of the similarity measurement, a quantitative fouling descriptor being associated with each of said packets, and in which, for a set of one or several vectors of fouling indicators of the inspected tube or plate portion:
each of the vectors of indicators of the set of vectors of fouling indicators of the inspected tube or plate portion is compared with the respective centers or averages of the packets of the database,
m packets of vectors of fouling indicators are selected on the basis of this comparison,
the fouling level of the inspected tube or plate portion is determined from quantitative descriptors associated with the m packets of selected vectors of indicators.

The partitioning of the space of the indicators may be obtained in diverse ways. It may be set arbitrarily a priori, or may use an algorithm which gives the packets or clusters, being more naturally disengaged from the set of vectors of indicators of the database (such as the so-called “K-means” algorithm). Once this partitioning has been carried out, for the half-plate to be inspected the number of tubes making it up is determined, belonging to each partition of the space of the vectors of indicators. The vector r=(r₁, . . . , rₖ) results from this wherein the rₖ component corresponds to the proportion of tubes of the half-plate belonging to the cluster k (one therefore has Σₖrₖ=1).

The estimation is then directly carried out on these vectors r, by for example searching for the N half-plates of the database for which the vectors rₙ, (n ∈ [[1, N]]) are the closest to the vector of the half-plate to be estimated in the sense of a given similarity measurement, typically a distance. Finally it is possible to calculate the average fouling by the average of the fouling cₙ, of the selected half-plates weighted by the calculated distances dₙ:

$$c = \frac{{Σ}_{n = 1}^{N} {d}_{n}^{- 1} {c}_{n}}{{Σ}_{n = 1}^{N} {d}_{n}^{- 1}}$$

It should be noted that the distributions of vectors of fouling indicators may be associated with spatial information, such as the position of tubes in the spacer plate, so as to correspond to the representative images of the spatial distribution of the fouling values. In this case, the fouling is estimated by means of an image recognition process, which may resume the principles stated above, in order to estimate the fouling by recognizing in the database, the image(s) the closest to those obtained for the inspected heat exchanger.

### Tube by Tube Estimation

According to another alternative, a set of vectors of fouling indicators is a vector of fouling indicators of a tube and the quantitative descriptor associated with said vector is a fouling level of said tube, said database dealing with at least M tubes from different heat exchangers, M≧2, said database including M vectors of fouling indicators of one passage, each associated with a fouling level of said passage of said tube.

In the example hereafter, and as earlier, the spacer plate portions are spacer half-plates, corresponding to the portion of the spacer plates present in the cold or hot branch of the heat exchanger, here a steam generator. For a given tube/plate intersection, the fouling level obtained for example by remote viewing examination is noted as c and θ is the vector of the qualitative indicators calculated earlier, after having determined the vectors of indicators θ of the inspected tube. Therefore M pairs {θ, c} are available in the database.

### Probabilistic Approach

According to this approach, after having determined the vectors of indicators of the tube (S30), the a posteriori fouling level c distribution p(c|θ) for the vectors of indicators θ is calculated from vectors of the database (step S31), and the fouling is determined by the sum of the a posteriori fouling distribution weighted with fouling levels (step S32).

Indeed, this so-called a posteriori least squares approach consists of minimizing the average quadratic estimation error defined by

$$\vert \hat{ε} \vert = {\sum }_{c} {( {c}_{est} - c )}^{2} p ( c \vert θ )$$

wherein p(c|θ) designates the fouling distribution of the vector of indicators θ (this is the a posteriori law). The estimator cₑₛₜ of the fouling minimizing the previous equation is given by the equation:

$${c}_{est} = {\sum }_{c} cp ( c \vert θ )$$

The a posteriori law may be given by Bayes theorem:

p(c|θ)∝p(θ|c)p(c)

wherein p(c) designates the a priori law and p(θ|c) is the likelihood of the indicators in the Bayes theory. The calculation of the a posteriori law may thus comprise an estimation of the a priori law p(c) and of the likelihood p(θ|c).

In order to express both of these probabilities, the interval of the possible fouling levels (from 0 to 100%) may be sampled in several consecutive windows Ck=[ck; ck+1] and p(c) and p(θ|c) calculated in each of the latter. Thus, the a priori law is obtained according to a ratio between:

the number Mₖ of tubes of the database having a fouling level c comprised in the interval [cₖ; cₖ₊₁], and

the total number of tubes in the database:

$$p ( c ∈ {C}_{k} ) = \frac{{N}_{k}}{Card ( database )}$$

wherein Nₖ represents the number of tubes of the database having fouling c comprised in the interval Cₖ, and Card(database) is the total number of tubes in the database.

The likelihood law is approached on c comprised on an interval [cₖ; cₖ₊₁] by a probability law [symbol] , preferably a Gaussian law, a Parzen modeling, or a weighted average of laws, depending on parameters cu to be determined, like what was indicated above:

p((θ)|c)≈ [symbol] (θ, ω)

For example, within the scope of Parzen modeling:

$$( θ \vert c ε {C}_{k} ) = \frac{1}{\sqrt{\vert {Σ}_{n} \vert} {( 2 π )}^{\frac{d}{2}} {h}^{d}} {\sum }_{j = 1}^{{N}_{k}} exp ( - \frac{1}{2 {h}^{2}} {( θ - {θ}_{j} )}^{T} {Σ}_{k}^{- 1} ( θ - {θ}_{j} ) )$$

Like in the case of the estimation per half-plate, the value h of the width of the Gaussians (for example here again h=0.5) should be set. In order to counter possible conditioning problems of the variance-covariance matrix of the vectors of indicators of the tubes belonging to the class Cₖ, Σₖ, is also possible here to approach its inverse matrix with the matrix formed of its sole inverse diagonal coefficients, according to

$${Σ}_{k}^{- 1} = {( {σ}_{i , j} )}^{- 1} \approx ( \begin{matrix}\frac{1}{{σ}_{1 , 1}} & … & 0 \\ ⋮ & ⋱ & ⋮ \\ 0 & … & \frac{1}{{σ}_{d , d}}\end{matrix} )$$

with i, j ∈ [[1, d]].

This calculation of the likelihood gives the possibility of rewriting the equation of the a posteriori law and of obtaining the expression of the a posteriori probability law in the interval Ck:

$$p ( c ε {C}_{k} \vert θ ) = \frac{p ( θ \vert c ε {C}_{k} ) p ( c ε {C}_{k} )}{{Σ}_{i} p ( θ \vert c ε {C}_{i} ) p ( c ε {C}_{i} )} = \frac{ ( θ , {ω}_{k} ) p ( c ε {C}_{k} )}{{Σ}_{i} ( θ , {ω}_{i} ) p ( c ε {C}_{i} )}$$

The estimation cₑₛₜ of the fouling (step S33) for the vectors of indicators θ of the inspected tube is inferred from the previous equation:

$${c}_{est} - {\sum }_{c} cp ( c \vert θ )$$

and is given by

$${c}_{est} = {\sum }_{c} 〈 {c}_{i} 〉 p ( c ε {C}_{i} \vert θ )$$

wherein <cᵢ> symbolizes the average fouling of the tubes belonging to the interval Cᵢ.

### Approach by Vector Quantification

The use of vector quantification techniques has the purpose of evaluating the fouling level of a tube according to the position of its vectors of indicators θ in the space of the vectors of indicators, relatively to the examples of vectors which make up the database. Schematically, the principle is to give to the inspected tube for which the fouling is to be evaluated, a fouling level similar to those of the tubes of the base which are close to its vectors of indicators θ.

As earlier, the sets of vectors indicating fouling of the database are packets each having a center or an average and grouping on the basis of a similarity measurement dealing with the values of said fouling indicators, the fouling indicators for which the values are the closest to said center or to said average, a quantitative descriptor of fouling being associated with each of said packets.

More specifically, the set of the vectors of indicators of the database is thus partitioned into K sets, for example with the so-called “K-means” algorithm. Once this step is carried out, each of the vectors of indicators of the set of fouling indicators are each compared with the respective centers or averages of the packets of the database, by means of a similarity measurement, for example by calculating the distances dₖ of the vectors of indicators θ of the inspected tube to each of the centers of the clusters (k ∈ [[1, K]]). Several types of distances may be used, from the customary Euclidean distance to similarity measurements taking into account the distribution of the data. From the latter, mention will be made of the Mahalanobis distance, which involves the variance-covariance matrix)Σₖ of the partition k and its center μₖ. The Mahalanobis distance between a vectors of indicators θ and the set of the data of the cluster k is then written as:

dₖ=\sqrt{(θ−Ξₖ)^{T}Σₖ⁻¹(θ−μₖ)}

Then there remains the estimation of the value of the fouling level of the tube according to these calculated distances. A solution is to proceed with an averaging of the average foulings <ck> of each packet weighted from similarity measurements, for example the reciprocal of the distances such as the distances dₖ calculated previously:

$${c}_{est} = \frac{{Σ}_{k = 1}^{K} {d}_{k}^{- 1} 〈 {c}_{k} 〉}{{Σ}_{k = 1}^{K} {d}_{k}^{- 1}}$$

It should be noted that the average may be calculated on the basis of the fouling levels of the totality of the packets, or on a selection of m of them on the basis of a comparison in the sense of a similarity measurement, as previously. It is therefore considered that the selection of the m packets may comprise all the packets, the closest packets, or all the packets except for certain of them which are set aside because of anomalies.

It will be noted that unlike the probabilistic approach, this estimation alternative by vector quantification does not make any a priori on the set of available data. Indeed, at any moment, the a priori probability law of the fouling, p(c), is not involved. Now, the latter may prove to be strongly biased if certain ranges of fouling values are over-represented (or under-represented). This method is thus less dependent on the representativity of the database.

1. A method for evaluating the fouling of passages of a spacer plate of a heat exchanger with tubes, said passages being made along the tubes for crossing the spacer plate by a fluid, wherein, for at least one passage:
at least one measurement of a parameter depending on the fouling or on the presence of magnetite is conducted in the vicinity of the passage by means of an eddy current probe,
at least one fouling indicator of said passage is derived from this measurement, wherein the fouling is evaluated by comparing a set of one or several vectors of fouling indicators with a dimension of at least two, built from the thereby obtained fouling indicators, with a plurality of sets of vectors of fouling indicators contained in a database, each of said sets of vectors of indicators being associated with a quantitative fouling descriptor.

2. The method according to claim 1, wherein the sets of vectors of fouling indicators are represented by distributions of vectors of fouling indicators of passages of a spacer plate portion and the quantitative descriptor associated with each distribution is an average fouling level of the passages of said spacer plate portion, said database dealing with at least N portions of spacer plates of different heat exchangers, N≧2 and including N distributions of vectors of indicators each associated with an average fouling level of the passages of said spacer plate portion.

3. The method according to claim 2, wherein:
the distribution of vectors of indicators Pₜₑₛₜ(θ) of the inspected plate portion is determined,
a similarity measurement dₙ, between the distribution of vectors of indicators Pₜₑₛₜ(θ) of the inspected spacer plate portion and each of the distributions of vectors of indicators Pₙ(θ) of the database is calculated,
the K distributions of vectors of indicators Pₙ(θ) of the database are selected, for which the similarity measurements dₙ with the distribution of vectors of indicators Pₜₑₛₜ(θ) of the inspected spacer plate portion are the greatest,
the fouling is determined from fouling levels associated with said selected K distributions of vectors of indicators Pₙ(θ) of the database.

4. The method according to claim 3, wherein the determination of the fouling comprises a step according to which:
an average of the fouling levels associated with said selected K distributions of vectors of indicators Pₙ(θ) of the database is calculated, each fouling level being weighted by the similarity measurements between the distribution of vectors of indicators Pₙ(θ) of the database with which said fouling level is associated and the distribution of vectors of indicators Pₜₑₛₜ(θ) of the inspected spacer plate portion.

5. The method according to claim 3, further comprising a determination of an evaluation of the uncertainty on the thereby determined fouling, on the basis of the measurement of the similarity between the thereby selected K distributions of vectors of indicators Pₙ(θ) of the database and the distribution of vectors of indicators Pₜₑₛₜ(θ) of the inspected spacer plate portion and/or of the variability of the quantitative descriptors associated with the selected distributions of vectors of indicators of a spacer plate portion.

6. The method according to claim 3, wherein the calculation of the similarity measurement dₙ between the distribution of vectors of indicators Pₜₑₛₜ(θ) of the inspected spacer plate portion and each of the distributions of vectors of indicators Pₙ(θ) of the database comprises an estimation of the distributions by means of a probability law model [symbol] , preferably a Gaussian law, a Parzen modeling or a weighted average of probability laws.

7. The method according to claim 2, wherein the distributions of vectors of fouling indicators are associated with spatial information, so as to correspond to representative images of the spatial distribution of the fouling values.

8. The method according to claim 1, wherein a set of vectors of fouling indicators is a vector of fouling indicators of a tube and the quantitative descriptor associated with said vector is a fouling level of said tube, said database dealing with at least M tubes of different steam generators, M≧2, said database including M vectors of fouling indicators of a passage, each associated with a fouling level of said passage.

9. The method according to claim 8, wherein:
the vectors of indicators θ of the inspected tube is determined,
the a posteriori fouling level distribution p(c|θ) is calculated for the vectors of indicators θ, from vectors of indicators of the database,
the fouling is determined by the sum of the a posteriori fouling distribution p(c|θ) weighted by the fouling levels c.

10. The method according to claim 9, wherein the calculation of the a posteriori law comprises an estimation of the a priori law p(c) and of the likelihood p(θ|c).

11. The method according to claim 10, wherein the a priori law is determined by a ratio between:
the number Mₖ of tubes of the database having a fouling level c comprised in an interval [cₖ; cₖ₊₁], and
the total number of tubes in the database.

12. The method according to claim 9, wherein the likelihood law is approached on c comprised in an interval [cₖ; cₖ₊₁] by a probability law [symbol] , preferably a Gaussian law, a Parzen modeling, or a weighted average of laws.

13. The method according to claim 1, wherein the set of vectors of fouling indicators of the database are packets of vectors of indicators each having a center or an average and grouping, on the basis of a similarity measurement dealing with said vectors of fouling indicators, the vectors of fouling indicators which are the closest, in the sense of the similarity measurement, to said center or to said average, a quantitative fouling descriptor being associated with each of said packets, and wherein, for a set of one or several vectors of fouling indicators of the inspected tube or plate portion:
each of the vectors of indicators of the vectors of fouling indicators of the inspected tube or plate portion is compared with the respective centers or averages of the packets of the database by a similarity measurement,
m packets of vectors of fouling indicators are selected on the basis of this comparison,
the fouling level of the inspected tube or plate portion is determined from quantitative descriptors associated with the m packets of selected vectors of indicators.

14. The method according to claim 13, wherein the fouling level of the inspected tube or plate portion is determined from an average of the quantitative descriptors of each packet weighted from the calculated similarity measurements.

15. A computer program product comprising program code instructions for executing the steps of the method according to claim 1 when said program is executed on a computer.
